(19) United States
(12) Patent Application Publication
(10) Pub. No.: US 2026/0009662 A1
(43) Pub. Date: Jan. 8, 2026

(54) ROTATABLE PLATFORM

(71) Applicants: Chin-Hsing CHUO, Taichung City (TW); Chin-Yen WANG, Taichung City (TW)

(72) Inventors: Chin-Hsing CHUO, Taichung City (TW); Chin-Yen WANG, Taichung City (TW)

(21) Appl. No.: 18/764,585

(22) Filed: Jul. 5, 2024

(51) Int. Cl. G01D 18/00; F16M 11/12

(52) U.S. Cl. CPC G01D 18/00; F16M 11/12; G01D 2218/10

(57) ABSTRACT

A rotating platform is provided, wherein the rotating platform includes: a base including support members and at least one rotatable member connecting two support members of the support members, one of the support members being configured to support at least one tested component; a signal integration module disposed on one of the support members and configured to be in communication with the at least one tested component to integrate and convert a signal from the at least one tested component into a communication signal for transmission; and at least one rotatable connection unit configured to transmit the communication signal to a signal processing module, including a first signal module and a second signal module, the first signal module and the second signal module being respectively being disposed on the two support members of the support members.

### BACKGROUND OF THE INVENTION

### Field of the Invention

The present invention relates to a rotatable platform.

### Description of the Prior Art

A rotatable platform can be used in various applications such as display, transportation, and test simulation. The rotatable platform is a mechanical device that can be classified into 1-axis, 2-axis, and 3-axis types according to the number of rotatable axes. Generally, signal transmission is carried out through cables. However, when cables are assembled on two components rotatable relative to each other for signal transmission, the cables can become twisted and tangled, leading to breakage. Additionally, this limits the range of relative rotation between the two components, necessitating reverse rotation. When the number of tested components increases, the number of cables would increase accordingly. The massive twisting of cables will result in significant resistance and risk of breakage.

The present invention is, therefore, arisen to obviate or at least mitigate the above-mentioned disadvantages.

### SUMMARY OF THE INVENTION

The main object of the present invention is to provide a rotatable platform which can convert the analog signals of at least one tested component into communication signals for transmission without the issue of twisted and tangled cables.

To achieve the above and other objects, a rotating platform is provided, wherein the rotating platform includes: a base including a plurality of support members and at least one rotatable member, two support members of the plurality of support members being connected to each other by the at least one rotatable member and rotatable relative to each other, one of the plurality of support members being configured to support at least one tested component; a signal integration module disposed on one of the plurality of support members and configured to be in communication with the at least one tested component to integrate and convert a signal from the at least one tested component into a communication signal for transmission; and at least one rotatable connection unit configured to transmit the communication signal to a signal processing module, including a first signal module and a second signal module, the first signal module and the second signal module being respectively being disposed on the two support members of the plurality of support members.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of an exemplary embodiment of the present invention; and

FIG. 2 is a partial enlarged view of FIG. 1.

### DETAILED DESCRIPTION OF THE PREFERRED EMBODIMENTS

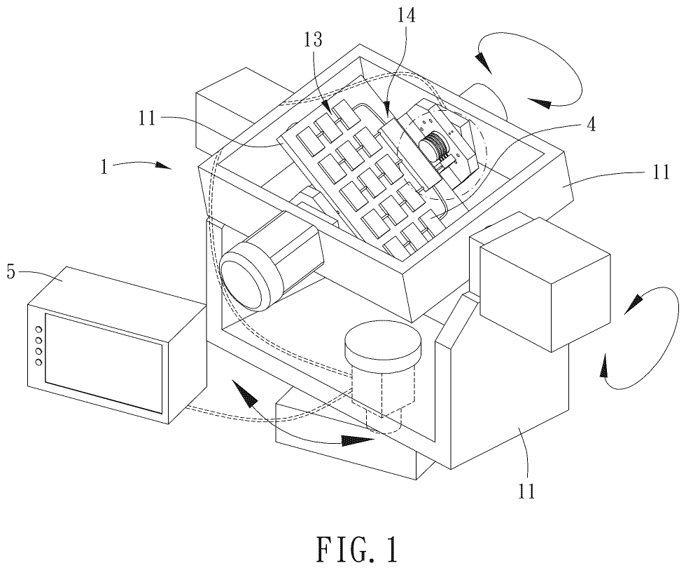

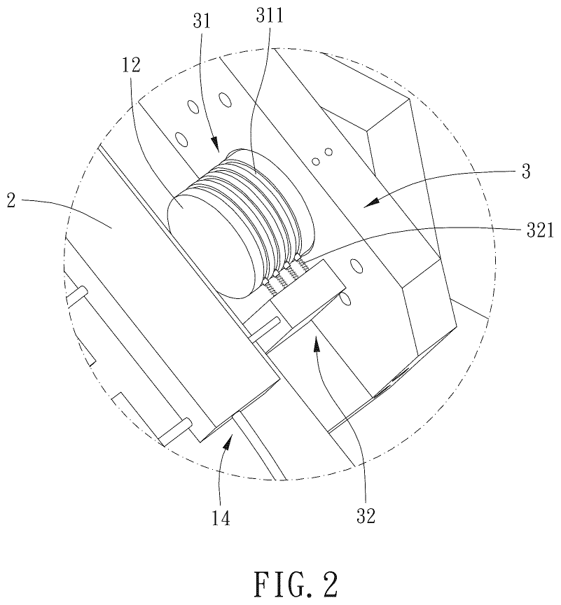

Please refer to FIGS. 1 to 2 for an exemplary embodiment of the present invention. A rotatable platform of the present invention includes a base 1, a signal integration module 2, and at least one rotatable connection unit 3.

The base 1 includes a plurality of support members 11 and at least one rotatable member 12. Two of the plurality of support members 11 are connected to each other by the rotatable member 12 and rotatable relative to each other. One of the plurality of support members 11 is configured to support at least one tested component 4. The tested component 4 may include, but is not limited to, at least one of a gyroscope, a level instrument and a position calibration instrument.

The signal integration module 2 is disposed on one of the plurality of support members 11. The signal integration module 2 is configured to be in communication with the at least one tested component 4 to integrate and convert a signal from the at least one tested component 4 into a communication signal for transmission. When the at least one tested component includes a plurality of tested components 4, the signal integration module 2 can effectively integrate complex analog signals, re-encode the analog signals into digital signals for communication and transmission, thereby significantly reducing the amount of transmission signal cables required.

The at least one rotatable connection unit 3 is configured to transmit the communication signal to a signal processing module 5. The at least one rotatable connection unit 3 includes a first signal module 31 and a second signal module 32, the first signal module 31 and the second signal module 32 are disposed on the two support members 11 of the plurality of support members 11 connected by the rotatable member 12, respectively, to transmit signals during the rotation process.

Specifically, the first signal module 31 is disposed on the at least one rotatable member 12, and the second signal module 32 is disposed on the support member 11 that supports the tested component 4. The first signal module 31 electrically contacts the second signal module 32 and is continuously rotatable for at least 360 degrees, which allows the two support members 11 connected by the rotatable member 12 to rotate continuously in the same direction without being restricted by the traditional cables which might be twisted and broken.

Specifically, the first signal module 31 includes a plurality of conductive transmission rings 311 arranged at intervals, and the second signal module 32 includes a plurality of conductive transmission members 321 arranged at intervals. The plurality of conductive transmission members 321 electrically contact the plurality of conductive transmission rings 311 respectively, ensuring continuous electrical conduction during rotation of the rotatable member 12. In this embodiment, the rotatable member 12 is columnar, and the conductive transmission rings 311 are recessed on the outer surface of the rotatable member 12, and the conductive transmission members 321 laterally contact the conductive transmission rings 311 respectively. In other embodiments, the rotatable member may be disc-shaped, and the conductive transmission rings are recessed on the end face of the rotatable member, and the conductive transmission members axially contact the conductive transmission rings respectively.

In this embodiment, the at least one rotatable member includes a plurality of rotatable members 12, the at least one rotatable connection unit includes a plurality of rotatable connection units 3, and respective rotation axes of the plurality of rotatable connection units 3 are perpendicular to each other and correspond to an X-axis, an Y-axis, and a Z-axis respectively. Additionally, one of the plurality of support members 11 may include a testing area 13 and a signal conversion area 14. The testing area 13 is configured to support the at least one tested component 4, and the signal integration module 2 is disposed on the signal conversion area 14. The signal conversion area 14 is located between the testing area 13 and the at least one rotatable connection unit 3, effectively separating complex circuitry from one side of the first signal module 31 remote from the first signal module 31 to prevent unexpected wire tangling with the at least one rotatable member 12.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A rotatable platform including:
a base including a plurality of support members and at least one rotatable member, two support members of the plurality of support members being connected to each other by the at least one rotatable member and rotatable relative to each other, one of the plurality of support members being configured to support at least one tested component;
a signal integration module disposed on one of the plurality of support members and configured to be in communication with the at least one tested component to integrate and convert a signal from the at least one tested component into a communication signal for transmission; and
at least one rotatable connection unit configured to transmit the communication signal to a signal processing module, including a first signal module and a second signal module, the first signal module and the second signal module being respectively being disposed on the two support members of the plurality of support members.

2. The rotatable platform of claim 1, wherein the at least one rotatable member includes a plurality of rotatable members, the at least one rotatable connection unit includes a plurality of rotatable connection units, and respective rotation axes of the plurality of rotatable connection units are perpendicular to each other and correspond to an X-axis, an Y-axis, and a Z-axis respectively.

3. The rotatable platform of claim 1, wherein one of the plurality of support members includes a testing area and a signal conversion area, the testing area is configured to support the at least one tested component, and the signal integration module is disposed on the signal conversion area.

4. The rotatable platform of claim 3, wherein the signal conversion area is located between the testing area and the at least one rotatable connection unit.

5. The rotatable platform of claim 1, wherein the first signal module is disposed on the at least one rotatable member, the second signal module is disposed on one of the plurality of support members supporting the at least one tested component, and the first signal module electrically contacts the second signal module and is continuously rotatable for at least 360 degrees.

6. The rotatable platform of claim 4, wherein the at least one rotatable member includes a plurality of rotatable members, the at least one rotatable connection unit includes a plurality of rotatable connection units, and respective rotation axes of the plurality of rotatable connection units are perpendicular to one another and correspond to an X-axis, an Y-axis, and a Z-axis respectively; the first signal module is disposed on the at least one rotatable member, the second signal module is disposed on one of the plurality of support members supporting the at least one tested component, and the first signal module electrically contact the second signal module and is continuously rotatable for at least 360 degrees; the first signal module includes a plurality of conductive transmission rings arranged at intervals, the second signal module includes a plurality of conductive transmission members arranged at intervals, the plurality of conductive transmission members electrically contact the plurality of conductive transmission rings respectively.
